(19) United States
(12) Patent Application Publication
(10) Pub. No.: US 2015/0285532 A1
(43) Pub. Date: Oct. 8, 2015

(54) HEAT CONVERSION MEMBER AND HEAT CONVERSION LAMINATE

(71) Applicant: KABUSHIKI KAISHA TOYOTA JIDOSHOKKI, Kariya-shi, Aichi (JP)

(72) Inventors: Takuhito Tsutsui, Kariya-shi (JP); Toru Sasatani, Kariya-shi (JP); Kazuto Noritake, Kariya-shi (JP); Norihito Takeuchi, Kariya-shi (JP)

(73) Assignee: KABUSHIKI KAISHA TOYOTA JIDOSHOKKI, Kariya-shi, Aichi (JP)

(21) Appl. No.: 14/437,694

(22) PCT Filed: Oct. 7, 2013
(86) PCT No.: PCT/JP2013/077251

§ 371 Date: Apr. 22, 2015

(30) Foreign Application Priority Data
Oct. 26, 2012 (JP) 2012-237314

(51) Int. Cl. F24J 2/00

(52) U.S. Cl. CPC F24J 2/0007

(57) ABSTRACT

The present invention addresses the problem of providing a heat conversion member capable of efficiently converting light to heat. This heat conversion member includes at least one type of semiconductor, and is characterized in that the band gap of the semiconductor is 0.5-1.2 eV.

### TECHNICAL FIELD

The present invention relates to a heat conversion member and to a heat conversion laminate.

### BACKGROUND ART

Photovoltaic power generation systems are known that convert sunlight to heat and utilize the heat for electric power generation. In the known systems, sunlight is collected with a collector and the collected sunlight is used to heat a heating medium (such as oil, dissolved salts or molten sodium) in a container or flow channel. Provision of covering materials, thin-films and the like on the surfaces of containers or flow channels is also being studied as a way of accelerating heating of the heating medium by the collected sunlight.

For example, PTL 1 proposes a cermet layer (ceramic+metal=cermet) as a member for conversion of sunlight to heat. Also, PTL 2, for example, proposes a solar energy collecting device having one section that receives the action of sunlight rays and another section that is situated at a gap from that section away from sunlight rays and receives the action of a heat absorption medium, and a section situated between the two sections, wherein the absorbing element is made of a covered sheet material, the sheet material having a sunlight ray-selective coating on one side of the sheet facing the section that receives the action of sunlight rays, and having a radiative coating on the other side of the sheet that faces the section that receives the action of the heat absorption medium.

### CITATION LIST

### Patent Literature

### [PTL 1] European Patent No. 1397622

### [PTL 2] Japanese Unexamined Patent Publication No. 57-55363

### SUMMARY OF INVENTION

### Technical Problem

At the current time, it is desirable to accelerate heating of heating media by collected sunlight and achieve more efficient light-to-heat conversion.

It is an object of the present invention to provide a heat conversion member that can efficiently convert light to heat. It is another object of the present invention to provide a heat conversion laminate comprising a heat conversion member that can efficiently convert light to heat.

### Solution to Problem

The means for achieving these objects is described by the following (1) to (10).

(1) A heat conversion member comprising at least one type of semiconductor,

the band gap of the semiconductor being between 0.5 eV and 1.2 eV.

(2) A heat conversion member comprising a composite material of at least one type of semiconductor and a transparent dielectric material,

the band gap of the semiconductor being between 0.5 eV and 1.2 eV.

(3) The heat conversion member according to (1) or (2) above, wherein the semiconductor comprises FeS₂.

(4) The heat conversion member according to (1) or (2) above, wherein the semiconductor comprises Mg₂Si.

(5) The heat conversion member according to (1) or (2) above, wherein the semiconductor comprises Zn₃As₂.

(6) The heat conversion member according to (1) or (2) above, wherein the semiconductor comprises Ge.

(7) The heat conversion member according to any one of (1) to (6) above, which has a film shape.

(8) The heat conversion member according to (7), wherein the film shape has a thickness of 1 nm to 10 μm.

(9) A heat conversion laminate having laminated at least one or more layers including the heat conversion member according to (7) or (8), and a metal layer.

(10) A heat conversion laminate having laminated at least a metal layer, one or more layers including the heat conversion member according to (7) or (8), and a transparent dielectric layer, in that order.

### Advantageous Effects of Invention

According to the present invention, there is provided a heat conversion member that can efficiently convert light to heat. According to the present invention, there is further provided a heat conversion laminate comprising a heat conversion member that can efficiently convert light to heat.

### BRIEF DESCRIPTION OF DRAWINGS

FIG. 1 is a graph showing an optical spectrum for sunlight and an optical spectrum for heat radiant light.

FIG. 2 is a cross-sectional schematic drawing showing a heat conversion laminate 1 as one embodiment of a heat conversion laminate according to the present invention.

FIG. 3 is a graph showing the results for the absorption properties of a Mo—SiO₂ cermet monolayer film (calculated).

FIG. 4 is a graph showing the results for the absorption properties of a Mo—SiO₂ cermet monolayer film (an actual film).

FIG. 5 is a graph showing the results for the absorption properties of a FeS₂—SiO₂ cersemi monolayer film.

FIG. 6 is a graph showing the results for the absorption properties of a Mg₂Si—SiO₂ cersemi monolayer film.

FIG. 7 is a graph showing the results for the absorption properties of a Ge—SiO₂ cersemi monolayer film.

FIG. 8 is a graph showing the results for the absorption properties of a Zn₃As₂—SiO₂ cersemi monolayer film.

FIG. 9 is a graph showing the results for the absorption properties of a Mo—SiO₂ cermet monolayer film.

FIG. 10 is a figure showing the laminar structures of FeS₂—SiO₂ cersemi laminates that operate at a heat collecting temperature of 580° C.

FIG. 11 is a figure showing the laminar structures of FeS₂—SiO₂ cersemi laminates that operate at a heat collecting temperature of 400° C.

FIG. 12 is a graph showing the results for the absorption properties of a FeS₂—SiO₂ cersemi laminate and a Mo—SiO₂ cermet laminate, that operate at a heat collecting temperature of 580° C.

FIG. 13 is a graph showing the results for the absorption properties of a FeS₂—SiO₂ cersemi laminate and a Mo—SiO₂ cermet laminate, that operate at a heat collecting temperature of 400° C.

FIG. 14 is a graph showing the results for the film efficiency of a FeS₂—SiO₂ cersemi laminate and a Mo—SiO₂ cermet laminate, that operate at a heat collecting temperature of 580° C.

FIG. 15 is a graph showing the results for the film efficiency of a FeS₂—SiO₂ cersemi laminate and a Mo—SiO₂ cermet laminate, that operate at a heat collecting temperature of 400° C.

FIG. 16 is a figure showing the laminar structures of Mo—SiO₂ cermet laminates that operate at a heat collecting temperature of 580° C.

FIG. 17 is a figure showing the laminar structures of Mo—SiO₂ cermet laminates that operate at a heat collecting temperature of 400° C.

### DESCRIPTION OF EMBODIMENTS

### (1) Heat Conversion Member

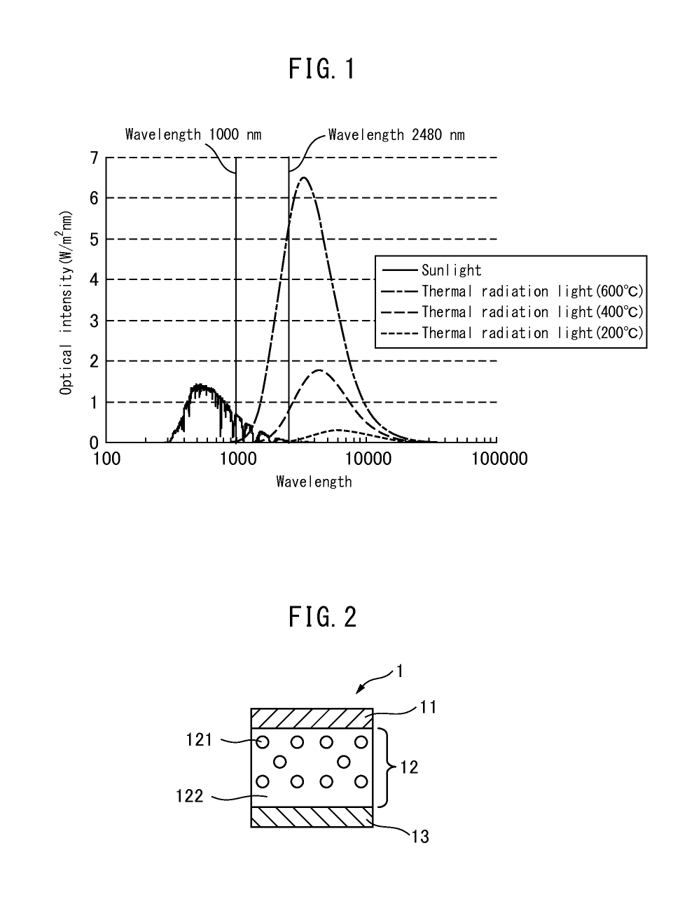

The heat conversion member of the present invention is a heat conversion member comprising at least one type of semiconductor, wherein the band gap of the semiconductor is between 0.5 eV and 1.2 eV. The heat conversion member of the present invention is also a heat conversion member comprising a composite material of one or more types of semiconductor and a transparent dielectric material, wherein the band gap of the semiconductor is between 0.5 eV and 1.2 eV. FIG. 1 is a graph showing an optical spectrum for sunlight and an optical spectrum for heat radiant light, and since the heat conversion member of the present invention has a steep change between absorption and non-absorption of sunlight with a wavelength in the range of 2480 nm to 1000 nm (light energy: 0.5 to 1.2 eV), it can efficiently absorb sunlight while minimizing heat release by heat radiation from the heating medium at 200° C. to 600° C., and can thus efficiently convert light to heat. If the slope of the absorbance for light is gentle and there is no steep change between absorption and non-absorption in a wavelength range of 2480 nm to 1000 nm, the solar absorbance will be low and the thermal radiation rate will increase, resulting in greater loss of thermal energy.

The one or more semiconductors in the heat conversion member of the present invention may be of a single type of semiconductor, or a mixture of two or more different types of semiconductor.

The semiconductor in the heat conversion member of the present invention is not particularly restricted, and examples include FeS₂, Mg₂Si, Zn₂As₂ and Ge.

The band gap of the one or more types of semiconductor in the heat conversion member of the present invention is between 0.5 eV and 1.2 eV and preferably between 0.7 eV and 1.0 eV.

The transparent dielectric material in the composite material in the heat conversion member of the present invention (hereunder simple referred to as “composite material”) is not particularly restricted, and examples include SiO₂, Al₂O₂ and AlN, with SiO₂ being preferred.

The one or more types of semiconductor in the heat conversion member of the present invention preferably include FeS₂, Mg₂Si, Zn₂As₂ or Ge. The values of the band gaps of FeS₂, Mg₂Si, Zn₂As₂ and Ge vary depending on the measuring method and measuring conditions, however generally speaking the value of the FeS₂ band gap is 0.95 eV, the value of the Mg₂Si band gap is 0.77 eV, the value of the Zn₂As₂ band gap is 0.86 eV and the value of the Ge band gap is 0.89 eV. The one or more types of semiconductor in the heat conversion member of the present invention may also be a mixture of at least two different compounds selected from the group consisting of FeS₂, Mg₂Si, Zn₂As₂ and Ge. The band gap can be measured by a photoabsorption method or photoelectron spectroscopy.

The heat conversion member of the present invention may be in any desired form, such as in the form of a film shape, tube shape, sheet shape or the like, however a film shape is preferred. The thickness of a film of the heat conversion member of the present invention may be any desired thickness so long as the effect of the present invention is exhibited; however, preferably a film of the heat conversion member of the present invention has a thickness of 1 nm to 10 μm, and more preferably it has a thickness of 5 nm to 100 nm.

The content of the one or more semiconductors in the heat conversion member of the present invention may be as desired, and for example, it may be 10 vol % or greater, 20 vol % or greater, 30 vol % or greater, 40 vol % or greater, 50 vol % or greater, 60 vol % or greater, 70 vol % or greater, 80 vol % or greater, 90 vol % or greater or 95 vol % or greater.

The heat conversion member of the present invention may also essentially consist entirely of the one or more semiconductors, in which case the content of the one or more semiconductors will be 100 vol %.

The heat conversion member of the present invention may also contain any desired material other than the one or more semiconductors. The heat conversion member of the present invention may yet also contain any desired material other than a composite material of the one or more semiconductors and a transparent dielectric material.

The heat conversion member of the present invention can be obtained by any desired publicly known production method. For example, the heat conversion member of the present invention can be produced by physical vapor phase deposition (PVD), sputtering or the like.

### (2) Heat Conversion Laminate

As one feature, the heat conversion laminate of the present invention has laminated one or more layers comprising a film-like heat conversion member of the present invention, and a metal layer, and it may have a metal layer and one or more layers comprising a film-like heat conversion member of the present invention laminated in that order, or the lamination may be in the reverse order.

As another feature, the heat conversion laminate of the present invention also have at least a metal layer, one or more layers comprising a film-like heat conversion member of the present invention and a transparent dielectric layer, laminated in that order.

The one or more layers comprising a film-like heat conversion member of the present invention in the heat conversion laminate of the present invention may be constructed as a photoabsorbing layer, and because it has a steep change between absorption and non-absorption in a sunlight wavelength range of 2480 nm to 1000 nm, it can efficiently absorb sunlight while minimizing heat release by heat radiation from the heating medium at 200° C. to 600° C., thereby efficiently convert light to heat. The thickness of the one or more layers comprising a film-like heat conversion member in the heat conversion laminate of the present invention may be any desired thickness so long as the effect of the present invention is exhibited, and it is preferably a thickness of 5 nm to 100 nm. The layer comprising the film-like heat conversion member in the heat conversion laminate of the present invention may be a single layer or multiple layers. The one or more layers comprising a film-like heat conversion member in the heat conversion laminate of the present invention may also include any materials other than the film-like heat conversion member.

The metal layer in the heat conversion laminate of the present invention may be constructed as an infrared anti-reflection layer. The metal layer in the heat conversion laminate of the present invention is not particularly restricted, and for example, it may be a molybdenum (Mo) layer, tungsten (W) layer, silver (Ag) layer, gold (Au) layer, copper (Cu) layer or the like, and is preferably a molybdenum (Mo) layer. The thickness of the metal layer in the heat conversion laminate of the present invention may be any desired thickness so long as the effect of the present invention is exhibited, and it is preferably a thickness of 100 nm or greater.

The transparent dielectric layer in the heat conversion laminate of the present invention may also be constructed as an anti-reflection layer. The transparent dielectric layer in the heat conversion laminate of the present invention is not particularly restricted, and examples include a SiO₂ layer, Al₂O₃, AlN layer or the like, with a SiO₂ layer being preferred. The thickness of the transparent dielectric layer in the heat conversion laminate of the present invention may be any desired thickness so long as the effect of the present invention is exhibited, and it is preferably a thickness of 10 nm to 500 nm.

The heat conversion laminate of the present invention can be obtained by any desired publicly known production method. For example, the heat conversion laminate of the present invention can be produced by physical vapor phase deposition (PVD), sputtering or the like.

The heat conversion laminate of the present invention will now be explained in greater detail with reference to FIG. 2. Incidentally, the heat conversion laminate of the present invention is not limited to the embodiment of the present invention shown in FIG. 2, such as is within the scope of the object and gist of the present invention.

FIG. 2 is a drawing showing a heat conversion laminate 1 as one embodiment of a heat conversion laminate according to an embodiment of the present invention. The heat conversion laminate 1 according to an embodiment of the present invention is formed from a transparent dielectric layer 11, a layer comprising a heat conversion member (photoabsorbing layer) 12, and a metal layer 13. Also, the layer comprising a heat conversion member (photoabsorbing layer) 12 comprises a semiconductor 121 and a transparent dielectric material 122. As shown in FIG. 2, the particles of the semiconductor 121 are dispersed within the transparent dielectric material 122.

### EXAMPLES

Examples will now be provided for a more concrete explanation of the present invention. The present invention is not limited to these examples, however, provided that the object and gist of the present invention are maintained.

### <Verification of Reproducibility of Film Properties According to Bruggeman's Effective Medium Approximation>

The reproducibility of the film properties according to Bruggeman's effective medium approximation was verified by Example 1 and Comparative Example 1.

### Example 1

The absorption properties of a Mo—SiO₂ cermet monolayer film were determined using Bruggeman's theory of computation. The term “cermet” means “ceramic+metal”.

The optical constants (n, k) of the Mo—SiO₂ cermet monolayer film were calculated by Bruggeman's effective medium approximation formula (formula (1) below). The optical constants for Mo and SiO₂ in the Mo—SiO₂ cermet were obtained by forming a monolayer film of each component by sputtering, and performing calculation from the measurement data obtained using a spectroscopic ellipsometer, and the reflectance property and the transmittance property as measured with a spectrophotometer.

$$f \frac{{( {n}_{s} - {ik}_{s} )}^{2} - {( n - ik )}^{2}}{{( {n}_{s} - {ik}_{s} )}^{2} + 2 {( n - ik )}^{2}} + ( 1 - f ) \frac{{( {n}_{c} - {ik}_{c} )}^{2} - {( n - ik )}^{2}}{{( {n}_{c} - {ik}_{c} )}^{2} + 2 {( n - ik )}^{2}} = 0 \qquad Formula ( 1 )$$

i: imaginary unit
f: Mo mixing ratio (vol %)
nₛ, kₛ: Optical constants of Mo₃Si
n_{c}, k_{c}: Optical constants of SiO₂

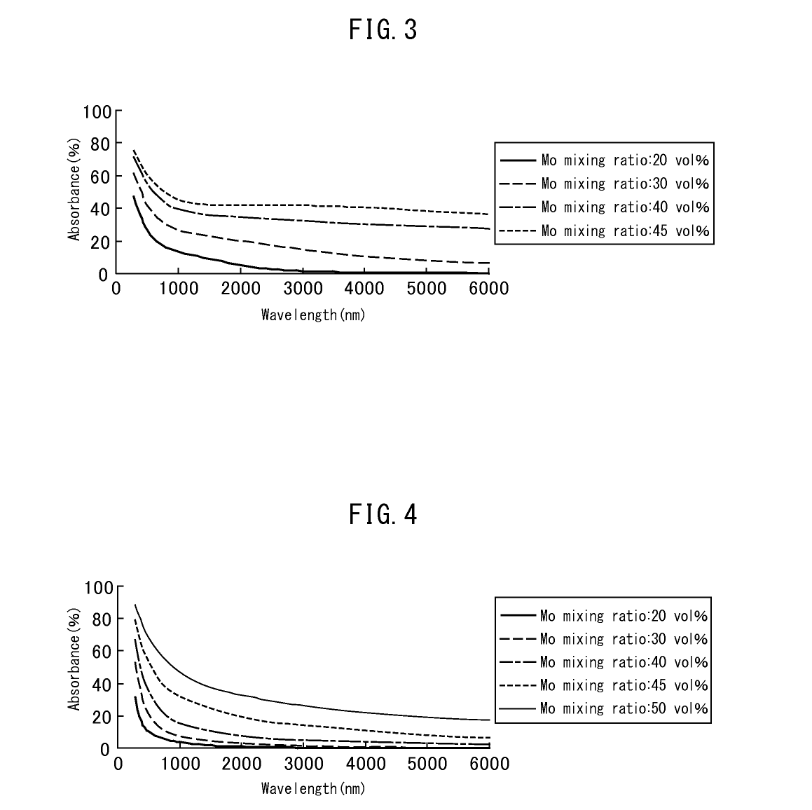

A multilayer film approximation based on the optical constants (n, k) for Mo—SiO₂ cermet obtained by calculation based on formula (1) was used to calculate the absorbance of the Mo—SiO₂ cermet monolayer film (corresponding to a film thickness of 30 nm). The results for the absorption properties of a Mo—SiO₂ cermet monolayer film (calculated) are shown in FIG. 3.

### Comparative Example 1

The absorption properties of a Mo—SiO₂ cermet monolayer film were determined using an actual film (prepared film).

A film was formed by simultaneous sputtering of Mo and SiO₂ on a quartz substrate that had been heated to a temperature of 500° C. to 600° C., to obtain a sample of a Mo—SiO₂ cermet monolayer film. The optical constants (refractive index n, extinction coefficient k) of the Mo—SiO₂ cermet were calculated for the obtained sample from the measurement data with a spectroscopic ellipsometer and the reflectance property and transmittance property measured with a spectrophotometer.

The calculated multilayer film approximation based on the optical constants (n, k) for Mo—SiO₂ cermet was used to calculate the absorbance of the Mo—SiO₂ cermet monolayer film (corresponding to a film thickness of 30 nm). The results for the absorption properties of the Mo—SiO₂ cermet monolayer film (an actual film) are shown in FIG. 4.

### <Verification Results>

As is clear by referring to FIG. 3 and FIG. 4, it was verified that the results for the absorption properties based on Bruggeman's theory of computation (FIG. 3) reasonably equated with the results for the absorption properties of the actual film (prepared film) (FIG. 4).

### <Evaluation of Absorption Properties of Heat Conversion Member>

The absorption properties of a heat conversion member were evaluated using Example 2 and Comparative Example 2.

### Example 2

Evaluation of the absorption properties of a heat conversion member of the present invention was conducted using a FeS₂—SiO₂ cersemi monolayer film, a Mg₂Si—SiO₂ cersemi monolayer film, a Ge—SiO₂ cersemi monolayer film and a Zn₂As₂—SiO₂ cersemi monolayer film. The term “cersemi” means “ceramic+semiconductor”.

The optical constants (n, k) of the FeS₂—SiO₂ cersemi, Mg₂Si—SiO₂ cersemi, Ge—SiO₂ cersemi and Zn₂As₂—SiO₂ cersemi were calculated by Bruggeman's effective medium approximation formula (formula (2) below). For the optical constants (nₛ, kₛ) for FeS₂, Ge and Zn₂As₂, refer to “Handbook of Optical Constants of Solids”, Edward D. Palik, Academic Press, Boston, 1985”, and for the optical constants (nₛ, kₛ) of Mg₂Si, refer to “T. Kato et al., J. Appl. Phys. 110, 063723(2011)”. Experimental data were used for the optical constants (n_{c}, k_{c}) of SiO₂.

$$f \frac{{( {n}_{s} - {ik}_{s} )}^{2} - {( n - ik )}^{2}}{{( {n}_{s} - {ik}_{s} )}^{2} + 2 {( n - ik )}^{2}} + ( 1 - f ) \frac{{( {n}_{c} - {ik}_{c} )}^{2} - {( n - ik )}^{2}}{{( {n}_{c} - {ik}_{c} )}^{2} + 2 {( n - ik )}^{2}} = 0 \qquad Formula ( 2 )$$

i: imaginary unit
f: Semiconductor mixing ratio (vol %)
nₛ, kₛ: Optical constants of semiconductor
n_{c}, k_{c}: Optical constants of SiO₂

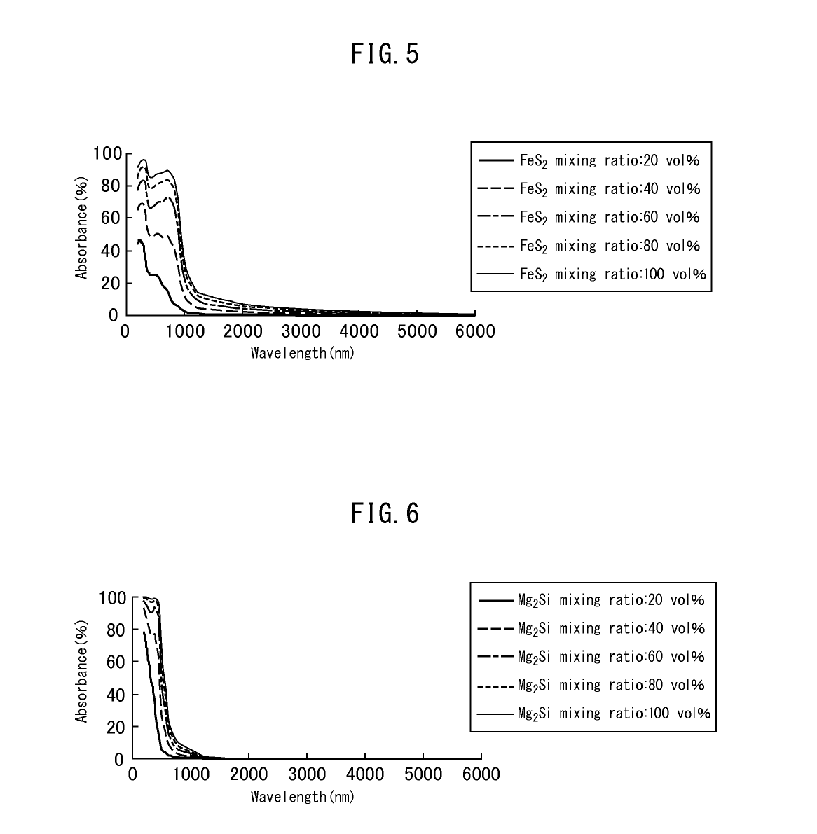

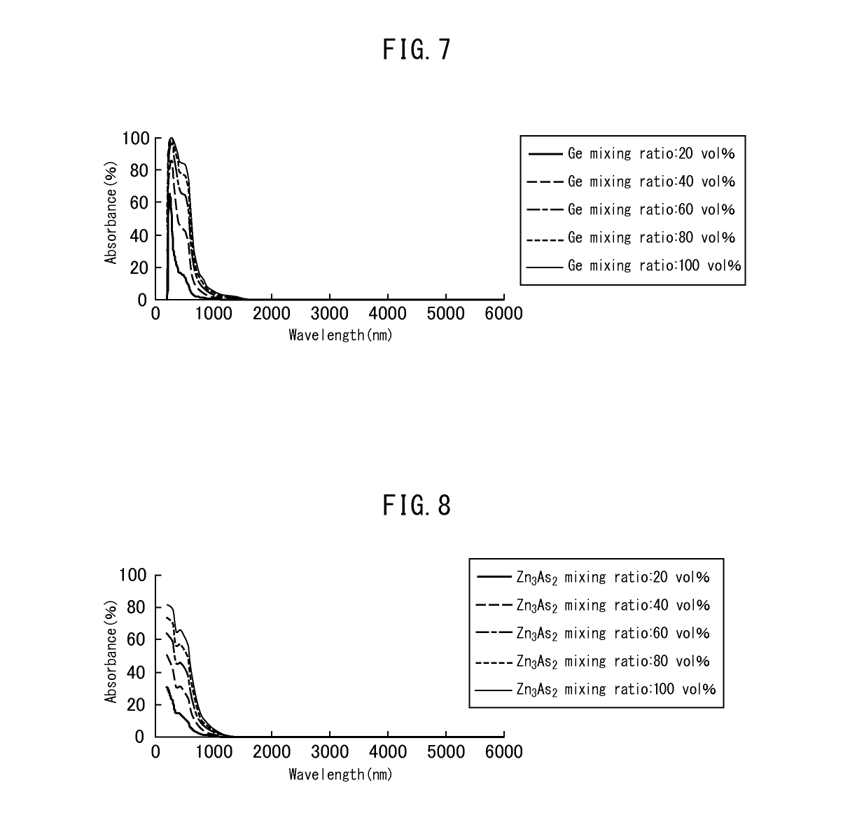

Using the multilayer film approximations based on the optical constants (n, k) for FeS₂—SiO₂ cersemi, Mg₂Si—SiO₂ cersemi, Ge—SiO₂ cersemi and Zn₃As₂—SiO₂ cersemi, obtained by each calculation using formula (2), each absorbance was calculated for the FeS₂—SiO₂ cersemi monolayer film, Mg₂Si—SiO₂ cersemi monolayer film, Ge—SiO₂ cersemi monolayer film and Zn₃As₂—SiO₂ cersemi monolayer film (corresponding to a film thickness of 30 nm). FIG. 5 to FIG. 8 show the results for the absorption properties of a FeS₂—SiO₂ cersemi monolayer film, Mg₂Si—SiO₂ cersemi monolayer film, Ge—SiO₂ cersemi monolayer film and Zn₃As₂—SiO₂ cersemi monolayer film.

### Comparative Example 2

The absorption properties of a Mo—SiO₂ cermet monolayer film were evaluated.

The optical constant (n, k) of the Mo—SiO₂ cermet monolayer film was calculated by Bruggeman's effective medium approximation formula (formula (1) below). The optical constants for Mo and SiO₂ in the Mo—SiO₂ cermet were obtained by forming a monolayer film of each component by sputtering, and performing calculation from the measurement data obtained using a spectroscopic ellipsometer, and the reflectance property and the transmittance property as measured with a spectrophotometer.

$$f \frac{{( {n}_{s} - {ik}_{s} )}^{2} - {( n - ik )}^{2}}{{( {n}_{s} - {ik}_{s} )}^{2} + 2 {( n - ik )}^{2}} + ( 1 - f ) \frac{{( {n}_{c} - {ik}_{c} )}^{2} - {( n - ik )}^{2}}{{( {n}_{c} - {ik}_{c} )}^{2} + 2 {( n - ik )}^{2}} = 0 \qquad Formula ( 1 )$$

i: imaginary unit
f: Mo mixing ratio (vol %)
nₛ, kₛ: Optical constants of Mo Si
n_{c}, k_{c}: Optical constants of SiO₂

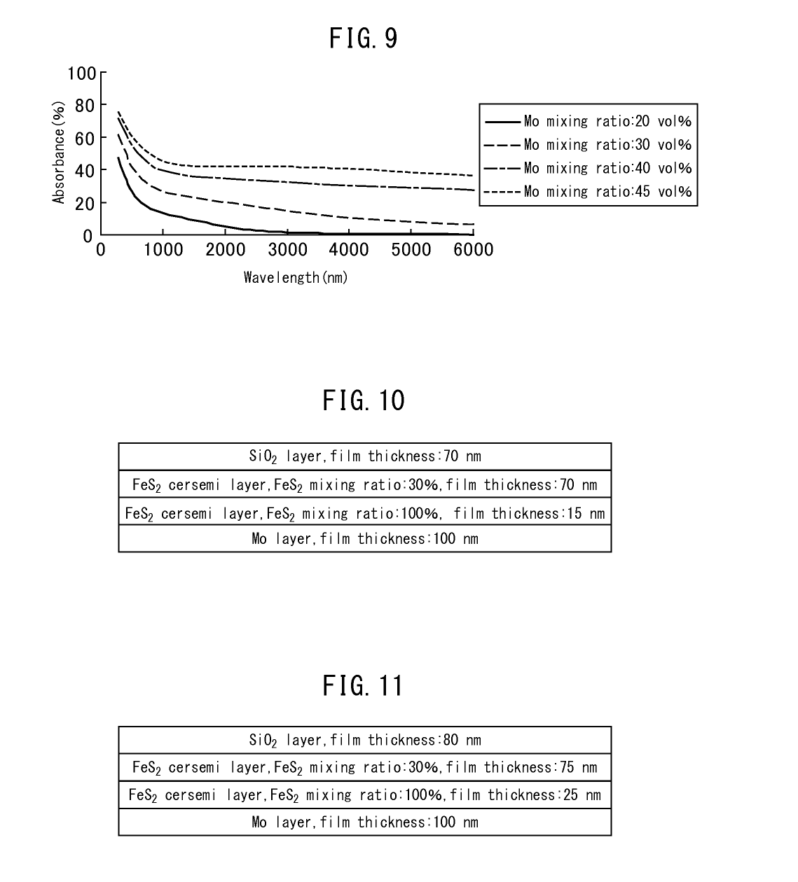

A multilayer film approximation based on the optical constants (n, k) for Mo—SiO₂ cermet obtained by calculation based on formula (1) was used to calculate the absorbance of the Mo—SiO₂ cermet monolayer film (corresponding to a film thickness of 30 nm). The results for the absorption properties of the Mo—SiO₂ cermet monolayer film are shown in FIG. 9.

### <Evaluation Results>

Referring to FIG. 5 to FIG. 8 and FIG. 9, the results for the absorption properties of the Mo—SiO₂ cermet monolayer film (FIG. 9) show a gentle slope for the absorbance of light in a wavelength range of 2480 to 1000 nm, whereas the results for the absorption properties of the FeS₂—SiO₂ cersemi monolayer film, Mg₂Si—SiO₂ cersemi monolayer film, Ge—SiO₂ cersemi monolayer film and Zn₃As₂—SiO₂ cersemi monolayer film (FIG. 5 to FIG. 8) show an abrupt slope for the absorbance of light in a wavelength range of 2480 to 1000 nm, by which it is seen that the FeS₂—SiO₂ cersemi monolayer film, Mg₂Si—SiO₂ cersemi monolayer film, Ge—SiO₂ cersemi monolayer film and Zn₃As₂—SiO₂ cersemi monolayer film efficiently absorb sunlight while minimizing heat release by heat radiation from the heating medium at 200° C. to 600° C.

### <Evaluation of Absorption Property of Heat Conversion Laminate and Evaluation of Film Efficiency>

Evaluation of the absorption properties of a heat conversion laminate and evaluation of the film efficiency were conducted using Example 3 and Comparative Example 3.

### Example 3

Evaluation of the absorption properties of a heat conversion laminate of the present invention and evaluation of the film efficiency were conducted using a FeS₂—SiO₂ cersemi laminate. The structure of the FeS₂—SiO₂ cersemi laminate that operates at a heat collecting temperature of 580° C. was a 4-layer structure comprising a SiO₂ layer (film thickness: 70 nm), a cersemi layer with a FeS₂ mixing ratio of 30% (film thickness: 70 nm), a cersemi layer with a FeS₂ mixing ratio of 100% (film thickness: 15 nm) and a Mo (molybdenum) layer (film thickness: 100 nm) from the light incident side, as shown in FIG. 10. The structure of the FeS₂—SiO₂ cersemi laminate that operates at a heat collecting temperature of 400° C. was a 4-layer structure comprising a SiO₂ layer (film thickness: 80 nm), a cersemi layer with a FeS₂ mixing ratio of 30% (film thickness: 75 nm), a cersemi layer with a FeS₂ mixing ratio of 100% (film thickness: 25 nm) and a Mo (molybdenum) layer (film thickness: 100 nm) from the light incident side, as shown in FIG. 11. The film structures (FeS₂ mixing ratio and film thickness) for the FeS₂—SiO₂ cersemi laminate that operates at a heat collecting temperature of 580° C. and the FeS₂—SiO₂ cersemi laminate that operates at a heat collecting temperature of 400° C., were set so as to exhibit the maximum film efficiency, as described below.

The optical constants (n, k) of the FeS₂—SiO₂ cersemi layers of the FeS₂—SiO₂ cersemi laminate that operates at a heat collecting temperature of 580° C. and the FeS₂—SiO₂ cersemi laminate that operates at a heat collecting temperature of 400° C. were determined by exactly the same calculation method as used for the optical constants (n, k) of Example 2. For the optical constants (n, k) of Mo, refer to “Handbook of Optical Constants of Solids”, Edward D. Palik, Academic Press, Boston, 1985”. Experimental data were used for the optical constants (n_{c}, k_{c}) of SiO₂.

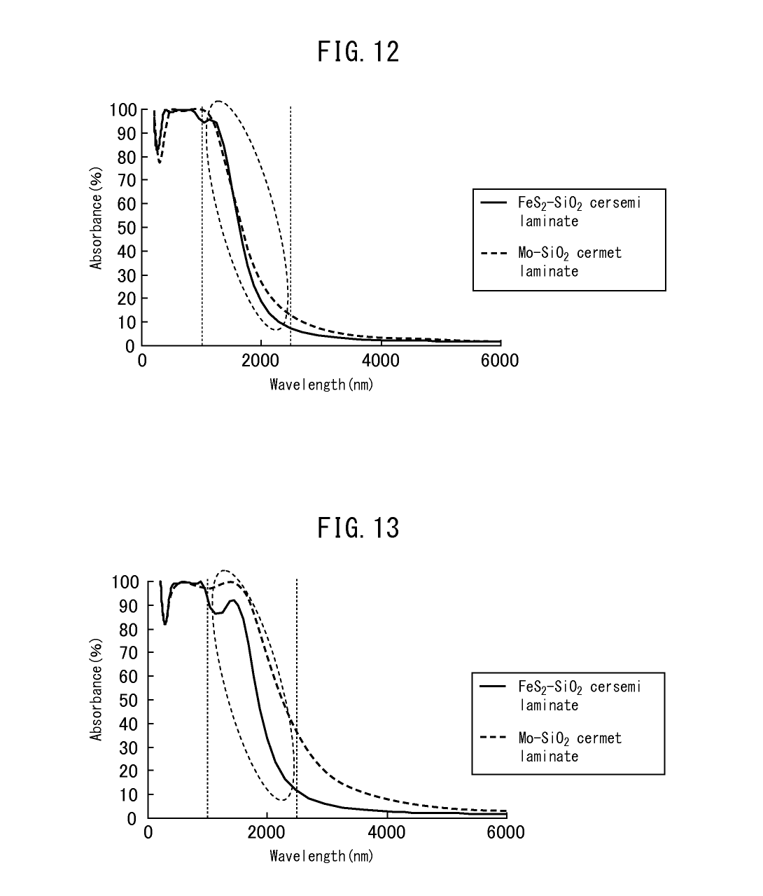

The absorbance of the FeS₂—SiO₂ cersemi laminate that operates at a heat collecting temperature of 580° C. was calculated using multilayer film approximation, based on the optical constants (n_{c}, k_{c}) of the SiO₂ layer (film thickness: 70 nm), the optical constants (n, k) of the cersemi layer with a FeS₂ mixing ratio of 30% (film thickness: 70 nm), the optical constants (n, k) of the cersemi layer with a FeS₂ mixing ratio of 100% (film thickness: 15 nm) and the optical constants (n, k) of the Mo (molybdenum) layer (film thickness: 100 nm). The results for the absorption properties of the FeS₂—SiO₂ cersemi laminate that operates at a heat collecting temperature of 580° C. are shown in FIG. 12.

Similarly, the absorbance of the FeS₂—SiO₂ cersemi laminate that operates at a heat collecting temperature of 400° C. was calculated using multilayer film approximation, based on the optical constants (n_{c}, k_{c}) of the SiO₂ layer (film thickness: 80 nm), the optical constants (n, k) of the cersemi layer with a FeS₂ mixing ratio of 30% (film thickness: 75 nm), the optical constants (n, k) of the cersemi layer with a FeS₂ mixing ratio of 100% (film thickness: 25 nm) and the optical constants (n, k) of the Mo (molybdenum) layer (film thickness: 100 nm). The results for the absorption properties of the FeS₂—SiO₂ cersemi laminate that operates at a heat collecting temperature of 400° C. are shown in FIG. 13.

Next, the values of the film efficiency η for the FeS₂—SiO₂ cersemi laminate that operates at a heat collecting temperature of 580° C. and the FeS₂—SiO₂ cersemi laminate that operates at a heat collecting temperature of 400° C., were determined by formula (3) below. The film efficiency η is an index representing the function of sunlight to heat conversion.

$$η = α - \frac{σ {T}^{4}}{CI} ɛ \qquad Formula ( 3 )$$

α: Solar absorbance
∈: Thermal radiation rate
σ: Stefan-Boltzmann constant
T: Absolute temperature
C: Amount of solar collection
I: Total solar energy, calculated from AM1.5 (solar intensity data based on ASTM)

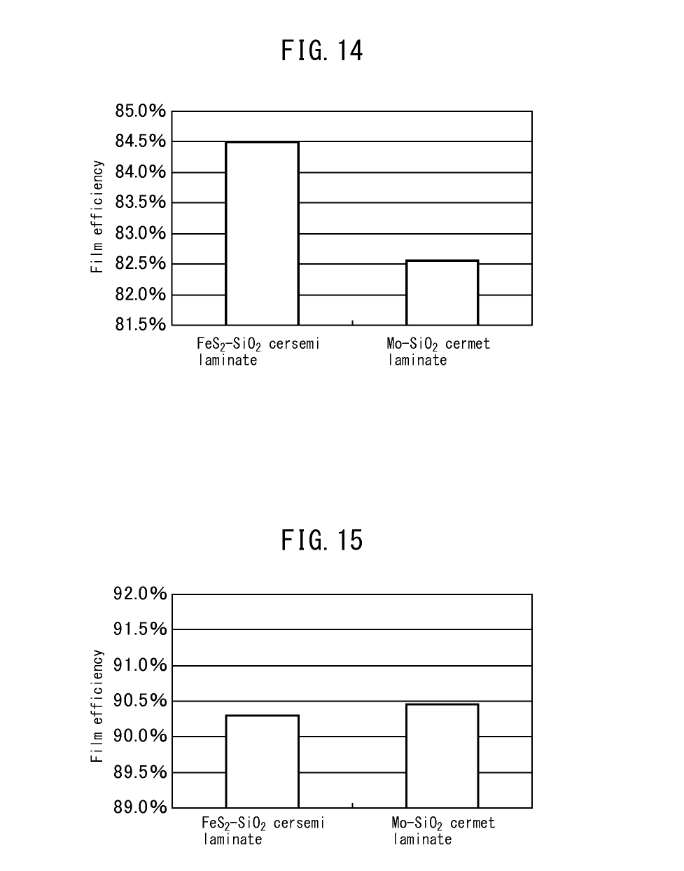

The results for the film efficiency η of the FeS₂—SiO₂ cersemi laminate that operates at a heat collecting temperature of 580° C. are shown in FIG. 14. The results for the film efficiency η of the FeS₂—SiO₂ cersemi laminate that operates at a heat collecting temperature of 400° C. are shown in FIG. 15.

### Comparative Example 3

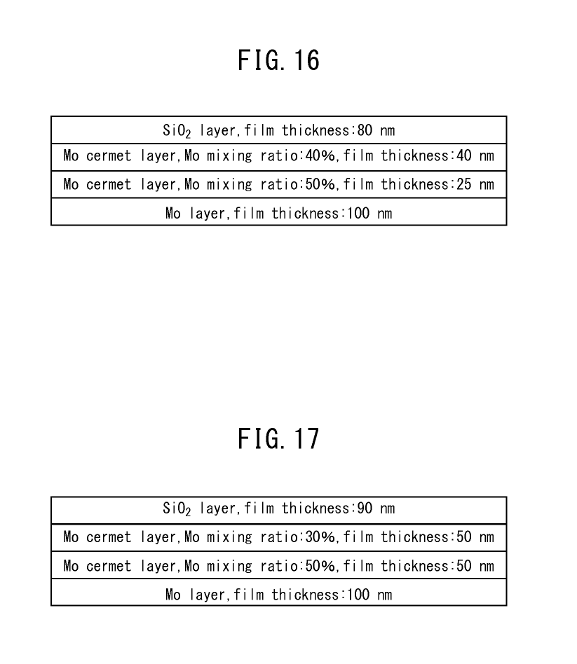

The absorption property of a Mo—SiO₂ cermet laminate and the film efficiency were evaluated. The structure of a Mo—SiO₂ cermet laminate that operates at a heat collecting temperature of 580° C. was a 4-layer structure comprising a SiO₂ layer (film thickness: 80 nm), a cermet layer film with a Mo mixing ratio of 40% (film thickness: 40 nm), a cermet layer with a Mo mixing ratio of 50% (film thickness: 25 nm) and a Mo (molybdenum) layer (film thickness: 100 nm), from the light incident side, as shown in FIG. 16. The structure of a Mo—SiO₂ cermet laminate that operates at a heat collecting temperature of 400° C. was a 4-layer structure comprising a SiO₂ layer (film thickness: 90 nm), a cermet layer film with a Mo mixing ratio of 30% (film thickness: 50 nm), a cermet layer with a Mo mixing ratio of 50% (film thickness: 50 nm) and a Mo (molybdenum) layer (film thickness: 100 nm), from the light incident side, as shown in FIG. 17. The film structures (FeS₂ mixing ratio and film thickness) for the Mo—SiO₂ cermet laminate that operates at a heat collecting temperature of 580° C. and the Mo—SiO₂ cermet laminate that operates at a heat collecting temperature of 400° C., were set so as to exhibit the maximum film efficiency, as described below.

The optical constants (n, k) of the Mo—SiO₂ cermet layers of the Mo—SiO₂ cermet laminate that operates at a heat collecting temperature of 580° C. and the Mo—SiO₂ cermet laminate that operates at a heat collecting temperature of 400° C. were determined by the same calculation method as used for the optical constants (n, k) of Comparative Example 2. For the optical constants (n, k) of Mo, refer to “Handbook of Optical Constants of Solids”, Edward D. Palik, Academic Press, Boston, 1985″. Experimental data were used for the optical constants (n_{c}, k_{c}) of SiO₂.

The absorbance of the Mo—SiO₂ cermet laminate that operates at a heat collecting temperature of 580° C. was calculated using multilayer film approximation, based on the optical constants (n_{c}, k_{c}) of a SiO₂ layer (film thickness: 80 nm), the optical constants (n, k) of a cermet layer with a Mo mixing ratio of 40% (film thickness: 40 nm), the optical constants (n, k) of a cermet layer with a Mo mixing ratio of 50% (film thickness: 25 nm) and the optical constants (n, k) of a Mo (molybdenum) layer (film thickness: 100 nm). The results for the absorption properties of the Mo—SiO₂ cermet laminate that operates at a heat collecting temperature of 580° C. are shown in FIG. 12.

Similarly, the absorbance of the Mo—SiO₂ cermet laminate that operates at a heat collecting temperature of 400° C. was calculated using multilayer film approximation, based on the optical constants (n_{c}, k_{c}) of a SiO₂ layer (film thickness: 90 nm), the optical constants (n, k) of a cermet layer with a Mo mixing ratio of 30% (film thickness: 50 nm), the optical constants (n, k) of a cermet layer with a Mo mixing ratio of 50% (film thickness: 50 nm) and the optical constants (n, k) of a Mo (molybdenum) layer (film thickness: 100 nm). The results for the absorption properties of the Mo—SiO₂ cermet laminate that operates at a heat collecting temperature of 400° C. are shown in FIG. 13.

Next, the values of the film efficiency η for the Mo—SiO₂ cermet laminate that operates at a heat collecting temperature of 580° C. and the Mo—SiO₂ cermet laminate that operates at a heat collecting temperature of 400° C., were determined by formula (3) below.

$$η = α - \frac{σ {T}^{4}}{CI} ɛ \qquad Formula ( 3 )$$

α: Solar absorbance
∈: Thermal radiation rate
σ: Stefan-Boltzmann constant
T: Absolute temperature
C: Amount of solar collection
I: Total solar energy, calculated from AM1.5 (solar intensity data based on ASTM)

The results for the film efficiency η of the Mo—SiO₂ cermet laminate that operates at a heat collecting temperature of 580° C. are shown in FIG. 14. The results for the film efficiency η of the Mo—SiO₂ cermet laminate that operates at a heat collecting temperature of 400° C. are shown in FIG. 15.

### <Evaluation Results>

Referring to FIG. 12 and FIG. 13, the results for the absorption properties of Mo—SiO₂ cermet laminates, that operate at a heat collecting temperature of 580° C. and that operate at a heat collecting temperature of 400° C., indicate that the slope of the absorbance for light in a wavelength range of 2480 to 1000 nm is gentle, while the results for the absorption properties of the FeS₂—SiO₂ cersemi laminate indicate that the slope of the absorbance for light in a wavelength range of 2480 to 1000 nm is abrupt, thus demonstrating that a FeS₂—SiO₂ cersemi laminate efficiently absorbs sunlight while minimizing heat release due to heat radiation from the heating medium at 200° C. to 600° C. Referring to FIG. 14, the film efficiency η of the Mo—SiO₂ cermet laminate that operates at a heat collecting temperature of 580° C. was 82.6%, while the film efficiency η of the FeS₂—SiO₂ cersemi laminate was 84.5%, and therefore the film efficiency η of the FeS₂—SiO₂ cersemi laminate was superior to the film efficiency η of the Mo—SiO₂ cermet laminate. Referring to FIG. 15, the film efficiency η of the Mo—SiO₂ cermet laminate that operates at a heat collecting temperature of 400° C. was 90.5%, while the film efficiency η of the FeS₂—SiO₂ cersemi laminate was 90.3%, and therefore the film efficiency η of the FeS₂—SiO₂ cersemi laminate and the film efficiency η of the Mo—SiO₂ cermet laminate were on the same level.

### REFERENCE SIGNS LIST

1 Heat conversion laminate
11 Transparent dielectric layer
12 Layer comprising heat conversion member (photoabsorbing layer)
13 Metal layer
121 Semiconductor
122 Transparent dielectric material

1-10. (canceled)

11. A light-to-heat conversion member comprising a composite material of one or more kinds of semiconductor and a transparent dielectric material,
the band gap of the semiconductor being between 0.5 eV and 1.2 eV.

12. The light-to-heat conversion member according to claim 11, wherein the semiconductor comprises FeS₂.

13. The light-to-heat conversion member according to claim 11, wherein the semiconductor comprises Mg₂Si.

14. The light-to-heat conversion member according to claim 11, wherein the semiconductor comprises Zn₃As₂.

15. The light-to-heat conversion member according to claim 11, wherein the semiconductor comprises Ge.

16. The light-to-heat conversion member according to claim 11, which has a film shape.

17. The light-to-heat conversion member according to claim 16, wherein the film shape has a thickness of 1 nm to 10 μm.

18. A light-to-heat conversion laminate having laminated at least one or more layers including the light-to-heat conversion member according to claim 16, and a metal layer.

19. A light-to-heat conversion laminate having laminated at least a metal layer, one or more layers including the light-to-heat conversion member according to claim 16, and a transparent dielectric layer, in that order.
